(19) United States
(12) Patent Application Publication
(10) Pub. No.: US 2026/0119811 A1
(43) Pub. Date: Apr. 30, 2026

(54) APPARATUS FOR THE COGNITIVELY IMPAIRED

(71) Applicant: Sony Group Corporation, TOKYO (JP)

(72) Inventor: Brant L. Candelore, San Diego, CA (US)

(21) Appl. No.: 18/927,901

(22) Filed: Oct. 26, 2024

(51) Int. Cl. G06F 40/40; G06F 3/16; G06V 40/16; G10L 13/027; G10L 17/22

(52) U.S. Cl. CPC G06F 40/40; G06F 3/167; G06V 40/172; G10L 13/027; G10L 17/22

(57) ABSTRACT

Cognitively-impaired users and others can be provided with device-based assistance to help them converse with another person. According, in one aspect, an apparatus may include a processor system and storage accessible to the processor system. The storage may include instructions executable by the processor system to receive input from a sensor. Based on the input from the sensor, the instructions may be executable to identify data related to a person, other than a user, that is in the user's environment. The instructions may then be executable to control a head-mounted device (HMD) either through a speaker to output audio generated or through a display to output text based on the data. In some specific instances, a large language model (LLM) may be used to generate the text or audio.

### FIELD

The disclosure below relates to technically inventive, non-routine solutions that are necessarily rooted in computer technology and that produce concrete technical improvements. In particular, this disclosure relates to device-based hearing aids for the cognitively impaired and others.

### BACKGROUND

As recognized herein, people who are cognitively impaired may forget someone's name or have difficulty making conversation.

### SUMMARY

Present principles therefore recognize that electronic devices can aid a person when the user needs assistance, enhancing the user's life experiences in a way that the user themselves is unfortunately unable to do.

Accordingly, in one aspect an apparatus includes a processor system and storage accessible to the processor system. The storage includes instructions executable by the processor system to receive input from a sensor. Based on the input from the sensor, the instructions are executable to identify data related to a person, other than a user, that is in the user's environment. The instructions are also executable to control a speaker of a head-mounted device (HMD) to output audio generated based on the data.

In various non-limiting examples, the data may be processed by a large language model (LLM) to output text, and here the at least one processor system may then execute text-to-speech software to generate the audio based on the text.

Also in various non-limiting examples, the audio may indicate the name of the person, the person's relationship to the user, a hobby of the person, information about a child of the person, and/or a past interaction between the person and the user.

In some example implementations, the sensor may include a microphone. Here, the instructions may be executable to use input from the microphone to identify, via voice recognition, a name of the person. The data may thus be established at least in part by the identified name of the person according to this example. In some specific instances, the apparatus may even include the microphone itself.

In addition to or in lieu of the foregoing, the sensor may include a camera. Here, the instructions may be executable to use input from the camera to identify, via facial recognition, a name of the person. The data may thus be established at least in part by the identified name of the person according to this example. In some specific instances, the apparatus may even include the camera.

Still further, in some embodiments the HMD may be established by earbuds. The HMD may additionally or alternatively be established by a hearing aid. In some instances, the apparatus may include the HMD itself.

In another aspect, a method includes receiving input from a sensor. The method then includes identifying data related to a person, other than a user, that is in the user's environment based on the input from the sensor. The method then includes controlling a speaker of a head-mounted device (HMD) to output audio generated based on the data.

In some examples, the data may include a name of the person, and the audio may indicate the name of the person and a suggested prompt for the user to use converse with the person. In some cases, the prompt may be suggested via the audio, and the audio may include natural language indicating a potential topic of conversation between the user and the person. In one particular example, the audio may be generated using text-to-speech software and text output by a large language model (LLM).

In still another aspect, at least one computer readable storage medium (CRSM) that is not a transitory signal includes instructions executable by a processor system to identify data related to a person, other than a user, that is in the user's environment. The instructions are also executable to control a speaker of a head-mounted device (HMD) to output audio generated based on the data.

In certain instances, the instructions may be executable to provide the data, as input, to a large language model (LLM). The instructions may then be executable to receive an output from the LLM, where the output may be provided in response to the input. The output may suggest a topic of conversation for the user to use to converse with the person. The instructions may then be executable to use the output to generate the audio, where the audio may be generated via text-to-speech software based on text indicated in the output.

The details of the present disclosure, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example computing system consistent with present principles;

FIG. 2 shows an example graphical user interface (GUI) that may be presented on an HMD display consistent with present principles to provide potential topics of conversation that a user might then use to converse with another person;

FIG. 3 illustrates example logic in example flow chart format that may be executed by an apparatus/processor system consistent with present principles; and

FIG. 4 shows example artificial intelligence (AI) model architecture that may be implemented consistent with present principles; and

FIG. 5 shows an example settings GUI that may be presented on a display to configure one or more settings of an application and/or apparatus to operate consistent with present principles.

### DETAILED DESCRIPTION

Among other things, disclosed herein are various methods and apparatuses to use sound (and/or image) recognition as an aid to the cognitively impaired. A device operating consistent with present principles may therefore recognize faces (if a camera is available) and/or recognize voices (if a microphone is available) to then whisper names and other relevant information about other people to the user through earbuds or hearing aids. The device might not only state the name of the person, but also, if desired, the relationship to the user (e.g., daughter or sister), the name of the other person's spouse, and the name of any children of the other person as well as the children's ages (and maybe even their grade level in school). In addition, the outputs to the user may indicate the context of where the person interacted with the user in the past (e.g. golf group, maid, handyman, colleague, and Toastmaster's club). In addition, the device might whisper the hobby of the other person (e.g., fishing or gardening or growing large pumpkins), as well as any trips or other travel that the other person has taken recently. The user can take it from there in terms of conversation to create some small talk where the user might just need a little help.

In one specific example, a loved one might help the user program the device with the voices of other people for the device to recognize. This might include generating voice samples for everyone that interacts with the user on a regular basis to then program the device with a name for each voice for subsequent voice identification.

Accordingly, artificial intelligence (AI) principles are disclosed, including those related to LLMs, voice recognition, text-to-speech, and others. These techniques may be used to help an Alzheimer's patient or other person with dementia, for example, providing technical improvements over existing consumer electronics devices to cognitively help a person with conversation where appropriate.

Also note that in certain examples, an AI assistant may recognize someone approaching the user and then access someone's social media or email communications to the user themselves (e.g., the social media communications of the person approaching where that other person previously messaged the user themselves). In this way, the device can then use those communications to suggest topics of conversation such as “How did your trip to Europe go?”, “How did your recent trip to the beach go?”, “How is baby Owen doing?”, “How was baby Owen's birthday party?”, “Thank you for the cookies you sent”, “Thank you for the flowers”, etc.

With the foregoing in mind, it is to be generally understood that this disclosure relates to aspects of consumer electronics (CE) devices and other types of client devices and servers. Thus, devices herein may include server and client components which may be connected over a network such that data may be exchanged between the client and server components. The client components may include one or more computing devices including mobile smart phones, smart watches and other mobile devices, wearable devices, game consoles, extended reality (XR) headsets such as virtual reality (VR) headsets and augmented reality (AR) headsets, display devices such as televisions (e.g., smart TVs, Internet-enabled TVs), personal computers such as laptops, desktop, and tablet computers, and still other types of devices. These client devices may operate with a variety of operating environments. For example, a client device consistent with present principles may employ, as examples, Linux and Unix operating systems, operating systems from Microsoft, or operating systems from Apple or Google. These operating environments may be used to execute one or more browsing programs, such as a browser made by Microsoft, Apple, Google, or Mozilla. The operating environments may also be used to execute other Internet-networked dedicated mobile applications that can access websites hosted by the Internet servers over a network such as the Internet, a local intranet, or a virtual private network.

Servers and/or gateways may be used that may include one or more processors executing instructions that configure the servers to receive and transmit data over a network such as the Internet. Or a client and server can be connected over a local intranet or a virtual private network. A server or controller may be instantiated by a personal computer, mobile device, rack or blade server, etc.

As indicated above, information may be exchanged over a network between client devices and servers. To this end and for security, servers and/or clients can include firewalls, load balancers, temporary storage, and proxies, and other network infrastructure for reliability and security.

As used herein, instructions may refer to computer-implemented steps for processing information in the system. Instructions can be implemented in software, firmware or hardware, or combinations thereof and include any type of programmed steps undertaken by components of the system.

A processor may be any single-or multi-chip processor that can execute logic by means of various lines such as address lines, data lines, control lines and registers and shift registers. Moreover, any logical blocks, modules, and circuits described below can be implemented or performed with a processor/processor system such as a central processing unit (CPU), a digital signal processor (DSP), a field programmable gate array (FPGA) or other programmable logic device, an application specific integrated circuit (ASIC), discrete gate or transistor logic, discrete hardware components, or any combination thereof designed to perform the functions described herein. A processor can be implemented by a controller or state machine or a combination of computing devices.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

The functions and methods described below, when implemented in software, can be written in an appropriate language such as but not limited to C# or C++, and can be stored on or transmitted from a computer-readable storage medium such as a hard disk drive (HDD) or solid state drive (SSD), random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

In an example, a processor/processor system can access information over its input lines from data storage, such as a computer readable storage medium as referenced above, and/or the processor system can access information wirelessly from an Internet server by activating a wireless transceiver to send and receive data. Data typically is converted from analog signals to digital by circuitry between the antenna and the registers of the processor system when being received and from digital to analog when being transmitted. The processor system then processes the data through its shift registers to output calculated data on output lines, for presentation of the calculated data on the device, etc.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a”or “an”, “one or more”, and “at least one”can be used interchangeably herein.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

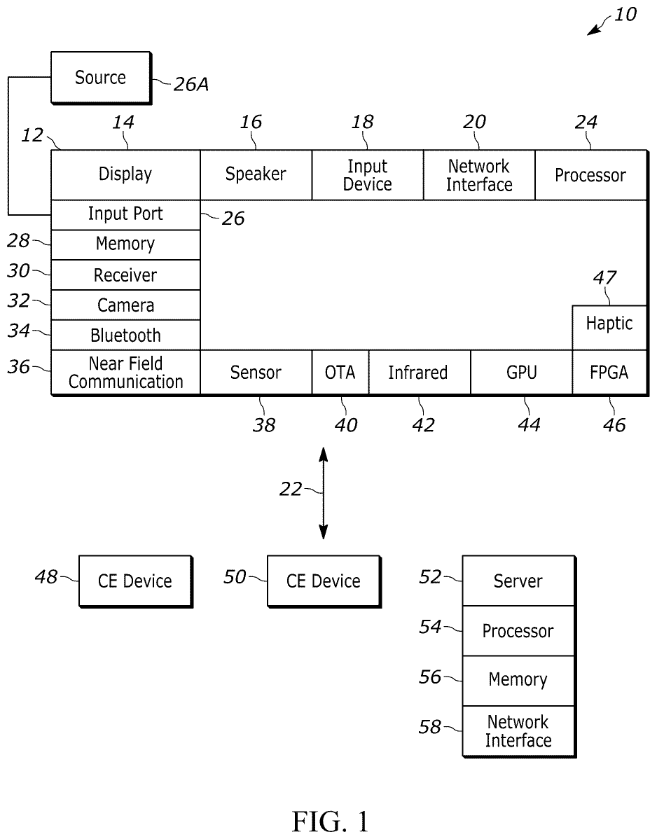

Referring now to FIG. 1, an example system 10 is shown, which may include one or more of the example devices mentioned above and described further below in accordance with present principles. The first of the example devices included in the system 10 is a consumer electronics (CE) device 12. The CE device 12 may be a computerized Internet enabled (“smart”) phone, a tablet computer, a laptop/notebook computer, a desktop computer, a head-mounted device (HMD) and/or headset such as smart glasses or AR or VR headset, another wearable computerized device, etc. Regardless, it is to be understood that the CE device 12 is configured to undertake present principles (e.g., communicate with other CE devices and servers to undertake present principles, execute the logic described herein, and perform other functions and/or operations described herein).

Accordingly, to undertake such principles the CE device 12 can be established by some, or all, of the components shown. For example, the CE device 12 can include one or more touch-enabled displays 14 that may be implemented by a high definition or ultra-high definition “4K” or higher flat screens. The touch-enabled display(s) 14 may include, for example, a capacitive or resistive touch sensing layer with a grid of electrodes for touch sensing consistent with present principles (e.g., to provide input to the GUIs discussed below).

The CE device 12 may also include an analog audio output port 15 to drive one or more external speakers or headphones, and may include one or more internal speakers 16 for outputting audio in accordance with present principles. The CE device 12 may also include at least one additional input device 18 such as one or more audio receiver/microphones, e.g., for detecting sound and entering audible commands to the CE device 12 to control the CE device 12. The example CE device 12 may also include one or more wired or wireless network interfaces 20 for communication over at least one network 22 such as the Internet, a WAN, a LAN, etc. under control of one or more processors of a processor system 24, such as a CPU or other processor mentioned above. Thus, the interface 20 may be, without limitation, a Wi-Fi transceiver and/or wireless telephony transceiver for communicating over a wireless cellular network (e.g., operated by Verizon, T-Mobile, or AT&T), both of which are examples of a wireless computer network interface. The network interface 20 may also be a wired or wireless modem or router or other suitable network interface.

It is to be understood that the processor system 24 may include one or more processors acting independently or in concert with each other to execute an algorithm, whether those processors are in one device or more than one device. The processor system 24 controls the CE device 12 to undertake present principles, including the other elements of the CE device 12 described herein such as controlling the display 14 to present images thereon and receiving input therefrom.

In addition to the foregoing, the CE device 12 may also include one or more input and/or output ports 26 such as a high-definition multimedia interface (HDMI) port or a universal serial bus (USB) port to physically connect to another CE device, and/or a headphone port to connect headphones to the CE device 12 for presentation of audio from the CE device 12 through the headphones. For example, the input port 26 may be connected wired or wirelessly to a cable or satellite source 26a of audio video content. Thus, the source 26a may be a separate or integrated set top box, or a satellite receiver. Or the source 26a may be a game console or disk player containing content.

The CE device 12 may further include one or more non-transitory computer memories/computer-readable storage media 28 such as disk-based or solid-state storage that are not transitory signals. In some cases, the media 28 may be embodied in the chassis/housing of the CE device 12 (e.g., as standalone devices) or as removable memory media or the below-described server(s).

Also, in some embodiments, the CE device 12 can include a position or location receiver such as but not limited to a cell phone transceiver, global positioning system (GPS) transceiver, and/or altimeter 30. This transceiver may therefore be configured to receive geographic position information from a satellite or cellphone base station (and/or determine an altitude at which the CE device 12 is disposed) and then provide the information to the processor system 24. However, it is to be understood that another suitable position receiver other than a GPS receiver, cell phone transceiver, and/or altimeter may be used consistent with present principles to determine the location of the CE device 12.

Continuing the description of the CE device 12, in some embodiments the CE device 12 may include one or more cameras 32 that may be thermal imaging cameras, digital cameras such as webcams, infrared (IR) sensors, and/or other types of cameras or other optical sensors integrated into the CE device 12 and controllable by the processor system 24 to gather pictures/images and/or video consistent with present principles. Also included on the CE device 12 may be a Bluetooth® transceiver 34 and/or other Near Field Communication (NFC) element 36 for communication with other devices using respective Bluetooth and/or NFC wireless technologies/communication standards. An example NFC element can be a radio frequency identification (RFID) element.

Further still, the CE device 12 may include one or more auxiliary sensors 38 that provide input to the processor system 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

Other sensor examples include a motion sensor such as an accelerometer, gyroscope, magnetometer, a speed and/or cadence sensor, an event-based sensor, a gesture sensor (e.g., for sensing gesture command), etc. In one specific example, the sensor 38 thus may be implemented as an inertial measurement unit (IMU) with motion sensors including individual accelerometers, gyroscopes, and magnetometers, and/or other components of that include a combination of accelerometers, gyroscopes, and magnetometers, to determine the location and orientation of the CE device 12 in three dimensions. A gyroscope consistent with present principles may sense and/or measure the orientation of the CE device 12 and provide related input to the processor system 24, an accelerometer consistent with present principles may sense acceleration and/or movement of the CE device 12 and provide related input to the processor system 24, and a magnetometer consistent with present principles may sense and/or measure directional movement of the CE device 12 and provide related input to the processor 122.

The CE device 12 may also include an over-the-air TV broadcast port 40 for receiving OTA TV broadcasts and providing the input to the processor system 24. In addition to the foregoing, it is noted that the CE device 12 may also include an IR transceiver 42 such as an IR data association (IRDA) device. A battery (not shown) may be provided for powering the CE device 12, as may a kinetic energy harvester that may turn kinetic energy into power to charge the battery and/or power the CE device 12. The CE device 12 may also be powered by an alternating current power supply. A graphics processing unit (GPU) 44 and field programmable gated array 46 also may be included.

One or more haptics/vibration generators 47 may also be provided for generating tactile signals/vibrations that can be sensed by a person holding or in contact with the device. The haptics generators 47 may thus vibrate all or part of the CE device 12 using an electric motor connected to an off-center and/or off-balanced weight via the motor's rotatable shaft so that the shaft may rotate under control of the motor (which in turn may be controlled by a processor such as the processor system 24) to create vibration of various frequencies and/or amplitudes as well as force simulations in various directions.

In addition to the CE device 12, the system 10 may include one or more other CE devices/types, which may include some or all of the components mentioned above in relation to the CE device 12. In one example, a second CE device 48 may be established by an Internet of things (IOT) device, a smartphone, a laptop computer, etc. A third CE device 50 is also shown in FIG. 1 and may include similar components as the other CE devices. Thus, in one example, the CE device 50 may be configured as a head-mounted device (HMD) that may include a heads-up transparent or non-transparent display for respectively presenting extended reality (XR) content such as AR content, VR, content, and/or mixed reality (MR) content. The XR content itself might include, as an example, one or more of the GUIs described below, presented stereoscopically. The HMD may be configured as a glasses-type display, or as goggle-type and/or VR-type display vended by various computer hardware manufacturers such as Apple, Oculus, Meta, etc. Additionally or alternatively, the HMD may also include one or more speakers to output audio consistent with present principles. In some specific instances, the HMD may be established by left and right ear buds that engage the user's head via the left/right pinnae and ear canals. Or rather than two earbuds, each with their own speaker but for a different ear, the HMD may be established by hearing aide-style devices that extend into the user's ear but also wrap around the back of the ear.

In the example shown, only three CE devices are shown, it being understood that fewer or more devices may be used. A device herein may implement some or all of the components shown for the CE device 12. Any of the components shown in the following figures may incorporate some or all of the components shown in the case of the CE device 12.

Now in reference to the afore-mentioned at least one server 52, it includes at least one server processor/processor system 54 and at least one tangible computer readable storage medium 56 such as disk-based or solid-state storage. The server 52 also includes at least one network interface 58 that, under control of the server processor 54, allows for communication with other illustrated devices over the network 22 (e.g., the Internet), and indeed may facilitate communication between the server 52 and any other servers/client devices as described herein. Note that the network interface 58 may be, e.g., a wired or wireless modem or router, Wi-Fi or Ethernet transceiver, or other appropriate interface such as, e.g., a wireless telephony transceiver.

Accordingly, in some embodiments the server 52 may be an Internet server or an entire server “farm” of multiple services. If desired, the server 52 may include/perform “cloud” functions such that the devices of the system 10 may access a “cloud” environment via the server 52 in certain example embodiments. Additionally or alternatively, the server 52 may be implemented by one or more computers in the same room as the other devices shown, or nearby.

The components shown in the following figures may include some or all components shown herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

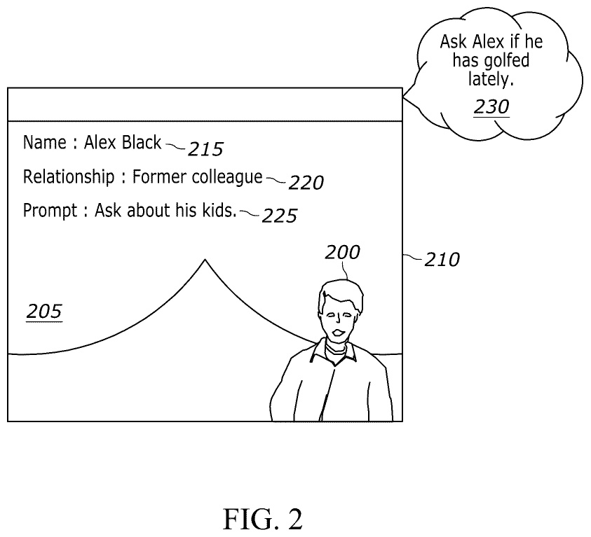

With the foregoing in mind, reference is now made to FIG. 2. Suppose an end-user is wearing a head-mounted device (HMD) when encountering another person 200, with the point of view of the user/HMD wearer being illustrated here. FIG. 2 therefore shows that the user is looking out of the HMD and at the person 200 through an electronic, see-through display 210 on the HMD. Also note that the HMD may also include one or more audio speakers (not shown). Further note that the HMD in this example may be smart glasses or an extended-reality headset, though other types of client devices may also be used.

Also suppose the user is having trouble remembering certain details about the person 200. To help, the HMD can use its outward-facing camera, or even a camera on an earbud or hearing aid of the user, to identify the name of the person 200 via facial recognition. Additionally or alternatively, the HMD can use its microphone to identify the name via voice recognition using a live voice sample of the person 200. Other techniques may also be used.

Based on identifying the name of the person 200, the HMD may present an indication 215 of the name as part of a graphical user interface (GUI) 205 presented on the display 210. Also based on identifying the name of the person, the HMD may go look up other information about the person 200 using the name. For example, the HMD may identify information from a business social networking site and then run the information through a large language model (LLM) to get an output from the LLM expressing the information in a way that relates to the user themselves. In the present instance, suppose the HMD has identified the person 200 as being employed by a company for which the user also previously worked. Based on this, the LLM may infer that the person 200 and user are former colleagues and, as such, the HMD may present an indication 220 that the user's relationship to the person 200 is that they are former colleagues.

The HMD might also consult an ancestry website, email account, short message service (SMS) text messages history, contracts list, etc. to gather other data that might either be used by the LLM to infer a relationship between the person 200 and user based on it, and/or that might be used by the LLM to provide suggestions of natural language prompts that the user might use to converse with the person 200. One such prompt may be provided as a visual indication 225 that suggests the user ask about the children of the person 200.

Also suppose the HMD has been set to provide audio outputs related to the person 200 in addition to or in lieu of visual outputs. An audible suggestion of a natural language prompt for the user to use to converse with the person 200 is therefore also illustrated in FIG. 2, this time via the speech bubble 230. As shown, the audio that is output at the HMD (via one or more of its speakers) may indicate that the user could ask the identified person 200 if the person 200 has golfed recently. This may be done responsive to the HMD determining from past conversation data that the user and person 200 have discussed the subject of golf prior to the present instance. In one particular example, the HMD may have determined as much by accessing transcripts of past conversations between the user and person 200 (e.g., as previously generated using a live microphone feed during the past conversation as well as speech-to-text software to generate the resulting transcript). It may thus be appreciated based on this example that visual and audio prompts may be suggested and may differ from each other, giving the user a robust selection of potential topics of conversation through different mediums to assist the user with conversation in a way that the user themselves might be unable to do.

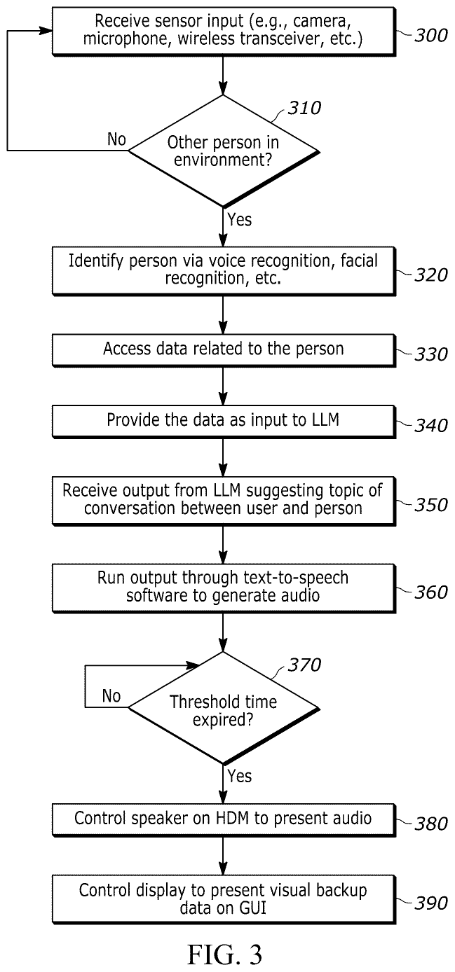

Now in reference to FIG. 3, this figure shows example logic that may be executed by an apparatus such as an HMD (or other client device) and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Further note that while the logic of FIG. 3 is shown in flow chart format, other suitable logic may also be used.

Beginning at block 300, the apparatus may receive input from a sensor on the HMD or connected device. The sensor might include a camera or microphone as mentioned above. Additionally or alternatively, the sensor might include a wireless transceiver such as a Wi-Fi transceiver or Bluetooth transceiver. Other types of sensors may also be used.

The logic may then proceed to decision diamond 310 where the apparatus may determine, based on the sensor input, whether another person has come into the user's environment. For example, the person's voice may be detected based on input from the microphone to determine the other person is present, with the input also being used to identify the name of person via voice recognition. As another example, the person's face may come into view of a camera on the HMD for the apparatus to determine the other person is present via computer vision, with the input also being used to identify the name of person via facial recognition. As yet another example, the person may be identified via wireless signals such as Wi-Fi or Bluetooth signals received at the HMD's wireless transceiver, with the signals being transmitted by the other person's own personal device. The wireless signals may therefore be received at the HMD and used to lookup the associated person's name by device ID (the device ID being transmitted in the wireless signals received at the HMD).

A negative determination at diamond 310 may cause the logic to revert back to block 300 to proceed again therefrom. Then responsive to an affirmative determination at diamond 310 that a person has entered the user's environment, the logic may proceed to block 320.

In addition to or in lieu of the foregoing affirmative determination at diamond 310, the HMD might also make a determination that the person has come within a threshold distance of the user to proceed to block 320. To do so, the apparatus may use a live camera feed from the HMD's outward-facing camera and computer vision to determine that the person has come within the threshold distance. The apparatus might also use wireless signals received from the other person's personal device (as assumed to be on their person) to then execute a received signal strength indicator (RSSI) algorithm using the received wireless signals to determine the distance from the user to the person. Other techniques may also be used. Also note that the threshold distance itself may be set by the user or a system administrator, and may be a distance that is still relatively near the user so as to avoid false positives where prompts might be suggested to the user for people that the user is not actually about to engage with conversationally owing to the distance between the two of them. Accordingly, in one particular example, the threshold distance may be five feet.

Once the logic reaches block 320, the apparatus may then identify the person using the sensor input received at block 300 if it has not already identified the person. The apparatus may therefore identify the person's first and last name using one or more of the techniques described herein, such as facial recognition, voice identification, wireless ID, etc.

The logic may then proceed to block 330 where the apparatus may access additional data about the recognized person (e.g., by using the identified name of the person to lookup other information associated with the name). Any of the types of data discussed herein may be used, such as website data, the person's web browser history, social media data for the user and/or person, personal contacts of the user and/or person, email account data for the user and/or person, and even customized metadata for the person as entered by the user themselves through voice input or text input.

The data accessed at block 330 as well as the person's identified name may then be provided as input to an LLM at block 340 for processing by the LLM consistent with present principles. Then at block 350 an output from the LLM may be received. The output may include a suggestion of a potential topic of conversation between the user and the person. The LLM may therefore be advantageously used for the output to be produced in natural language that is readily accessible and perceptible to someone who might be cognitively impaired.

Then at block 360, the output from the LLM (including at least the natural language text output) may be provided to text-to-speech software for generation of audio that corresponds to the text provided by the LLM. From block 360 the logic may then proceed to decision diamond 370.

At diamond 370 the logic may determine whether a threshold amount of time has expired. The threshold amount of time may be measured from when the person initially came within the user's environment (and/or came within the threshold distance). The apparatus may wait until expiration of the threshold amount of time before providing any audible or visual outputs to the user (to help the user converse with the person) to give the user their own chance to discuss whatever they want with the person without being distracted by audio and visual prompts. As such, the threshold amount of time may be five seconds.

For similar reasons, the threshold amount of time may additionally or alternatively be an amount of time from when the user initially looks at the other person and continues to look at that person (e.g., without breaking eye contact) but still does not speak to the person. Eye tracking software may therefore be used to track the user's eyes via inward-facing cameras on the HMD (and/or using cameras located elsewhere in the environment). And here too voice recognition may be executed to determine whether the user actually speaks during the threshold amount of time that the user is staring at the other person. Using this technique may thus help reduce false positives where another person might otherwise come within the threshold distance to the user but the user still might not wish to immediately converse with the person. Then when the user does in fact wish to speak with the person, the user might then begin looking at the person, with the apparatus tracking the threshold amount of time from when the user starts looking at the person to use its expiration as a trigger to affirmatively determine that the user does in fact wish to converse with the person but is having difficulty recalling potential topics of conversation. In response to that, the apparatus may then present one or more audible or visual suggested topics of conversation consistent with present principles. As such, in one specific implementation the threshold amount of time may be three seconds.

As yet another example, even without executing eye tracking, the apparatus may use the threshold amount of time from when the person initially came within the user's environment (and/or came within the threshold distance to the user) but during which the user still does not speak as a trigger for presenting audible and/or visual suggestions to the user. As such, in one specific implementation the threshold amount of time may still be three seconds.

A negative determination at diamond 370 may cause the logic to repeat at diamond 370 until an affirmative determination is made. Then responsive to an affirmative determination, the logic may proceed to block 380. At block 380 the apparatus may control a speaker on the HMD to present audio generated based on the output(s) from the LLM. The logic may then proceed to block 390 where the apparatus may control a display on the HMD to present visual data on a GUI to further aid the user. In some non-limiting instances, the visual data may be backup data in that a first, prioritized output from the LLM may be provided audibly to the user for quick and effortless understanding, while lesser-ranked outputs from the LLM may be provided visually on the GUI.

Thus, in certain example implementations, the audio presented at block 380 may indicate the name of the person, the person's relationship to the user, a hobby of the person that the user could then discuss with the person, information about a child of the person for the user to discuss with the person (e.g., name of the child and grade level in school), and/or a past interaction between the person and the user for the user to discuss with the person (e.g., where the user encountered the person in the past, to help the user recall where he/she knows the person from). The audio may then be presented to the user via the HMD's earbud speakers, hearing aide speaker, etc. In certain examples, the audio may even be presented at a first volume level that is a predetermined number of volume increments below a current (second) volume level for presentation of other audio at the HMD (such as music or amplified ambient audio to otherwise aid the user in hearing environmental sound/people speaking). This technique may allow the audio about the other person to still be heard by the user while reducing the likelihood that the other person would also hear the audio, helping give the appearance of the user remembering certain topics of conversation themselves. So as one specific example, if the volume scale for the HMD's audio goes from zero to ten and the currently-set volume for all other audio is seven, the preset number of increments may be three and therefore the audio presented at block 380 that is related to the other person may be output at a volume level of four.

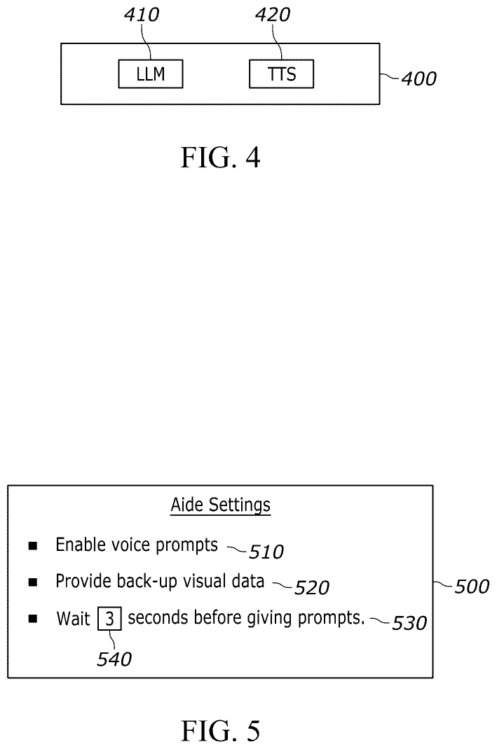

Continuing the detailed description in reference to FIG. 4, this figure shows example AI model architecture that may be implemented consistent with present principles. Thus, an overall AI model 400 may include a large language model (LLM) such as GPT4, Llama, Gemini, etc. The LLM 410 may be trained to generate conversation prompts consistent with present principles. For example, the LLM 410 may be trained on a dataset including data about a person (e.g., social media data, email data, etc.) and ground truth natural language suggestions for a user to use as a prompt to converse with the person. The LLM 410 may be trained in supervised fashion, through reinforcement learning, through self-learning and other deep learning techniques, etc.

FIG. 4 also shows that the model 400 may include a text-to-speech generator 420. The generator 420 may use one or more text-to-speech algorithms to generate a computerized, audible voice from the text provided by the LLM 410. Thus, in one specific example, data about another person that has been recognized by the HMD as coming within the threshold distance to the HMD's user may be provided as input to the LLM 410 for processing. The LLM 410 may then process the data to, according to its training, generate a natural language text output of one or more suggested prompts for the user to user to converse with the person. The text from the LLM 410 may then be provided to the text-to-speech generator 420 to generate corresponding audio to present to the user. Also note that some of the text from the LLM 410 may also be presented to the user visually, like in the example of FIG. 2 above.

Continuing the detailed description in reference to FIG. 5, it shows an example GUI 500 that may be presented on a display for an end-user to configure one or more settings of an apparatus or software application (“app”) to operate consistent with present principles. Each option discussed below may be selected by selecting the respective check box shown adjacent to that option, whether through cursor input, touch input, or another type of input.

As shown in FIG. 5, the GUI 500 may include a first option 510 that is selectable a single time to set or enable the apparatus to present voice (audio) prompts in multiple future instances consistent with present principles. For example, selection of the option 510 may set or configure an HMD to operate as described above in reference to FIGS. 2-4 to present audio to the user to aid the user in having conversations with different people over time in different conversation instances.

The GUI 500 may also include an option 520 that is selectable a single time to set or enable the apparatus to present visual prompts consistent with present principles. For example, selection of the option 520 may set or configure the HMD to operate as described above in reference to FIGS. 2-4 to present visual indications to the user to aid the user in having conversations with different people over time in different conversation instances.

FIG. 5 also shows that the GUI 500 may include another option 530. The option 530 may be selected to set or configure the apparatus to wait a threshold amount of time prior to providing audible and visual indications about another person to the user. Thus, numerical input may be entered into input box 540 for the end-user to set the threshold amount of time according to his/her preference. The threshold amount of time set via the option 530 might then be used at diamond 370 according to the logic of FIG. 3.

It may now be appreciated that certain relevant information may be inferred by an LLM and/or other software based on data accessible to the apparatus itself. This might include not just the name of another person, but also the user's relationship to person, the names of the person's children, whether someone just moved into a new house, etc. This may aid the user in conversing with the other person, technically improving the functions of an HMD but also enhancing the user's life experiences.

Before concluding, it is to be understood that although a software application for undertaking present principles may be vended with a device, present principles apply in instances where such an application is downloaded from a server to a device over a network such as the Internet. Furthermore, present principles apply in instances where such an application is included on a computer readable storage medium that is vended and/or provided by itself, where the computer readable storage medium is not a transitory signal and/or a signal per se.

It may now be appreciated that present principles provide, among other technical improvements, improved computer-based user interfaces that increase the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein.

1. An apparatus, comprising:
a processor system; and
storage accessible to the processor system and comprising instructions executable by the processor system to:
receive input from a sensor;
based on the input from the sensor, identify data related to a person, other than a user, that is in the user's environment; and
control a speaker of a head-mounted device (HMD) to output audio or to smart glasses to display text generated based on the data;
wherein the sensor comprises a microphone, and wherein the instructions are executable to:
use input from the microphone to identify, via voice recognition, a name of the person, the data established at least in part by the identified name of the person.

2. (canceled)

3. The apparatus of claim 1, wherein the text or audio indicates one of a hobby of the user, information about the child of the user

4. The apparatus of claim 1, wherein the text or audio indicates a past interaction between the person and the user, and wherein the past interactions between the person and the user are through email.

5-12. (canceled)

13. A method, comprising:
receiving input from a sensor;
based on the input from the sensor, identifying data related to a person, other than a user, that is in the user's environment;
determining that, for a threshold amount of time and while the person is within a threshold distance to the user, the user continually looks at the person but does not speak to the person; and
based on the determination, controlling a speaker or display of a head-mounted device (HMD) to output audio or text generated based on the data.

14-16. (canceled)

17. An apparatus, comprising:
at least one computer readable storage medium (CRSM) that is not a transitory signal, the at least one CRSM comprising instructions executable by a processor system to:
identify data related to a person, other than a user, that is in the user's environment;
determine that, for a threshold amount of time, the user continually looks at the person but does not speak to the person; and
based on the determination, control a speaker or visual display of a head-mounted device (HMD) to output audio or text generated based on the data.

18. The apparatus of claim 17, wherein the instructions are executable to:
provide the data, as input, to a large language model (LLM);
receive an output from the LLM, the output being provided in response to the input, the output suggesting a topic of conversation for the user to use to converse with the person; and
use the output to generate text, the text being displayed in smart glasses or converted to audio, the audio generated via text-to-speech software based on text indicated in the output.

19. The apparatus of claim 17, wherein the determination is a determination that, for the threshold amount of time and while the person is within a threshold distance to the user, the user continually looks at the person but does not speak to the person.

20. The apparatus of claim 17, wherein continually looking at the person comprises looking at the person without breaking eye contact.

21. The apparatus of claim 17, wherein the determination is made based on execution of eye tracking software.

22. The apparatus of claim 17, wherein the audio is first audio, and wherein the instructions are executable to:
based on the determination, control the speaker to output the first audio, the speaker controlled to output the first audio at a first volume level that is lower than a second volume level at which second audio is set to be output.

23. The apparatus of claim 22, wherein the first volume level is a predetermined number of volume increments below the second volume level, the second volume level being a current volume level at which the second audio is set to be output.

24. The apparatus of claim 23, wherein the second audio comprises music and/or amplified ambient audio.

25. The apparatus of claim 17, wherein the data comprises past conversation data for a past conversation between the person and the user.

26. The apparatus of claim 25, wherein the past conversation data indicates a subject discussed between the person and the user during the past conversation, and wherein one or more of the audio and the text indicate information about the subject.

27. The apparatus of claim 25, wherein the data comprises a transcript of the past conversation.

28. The apparatus of claim 27, wherein the instructions are executable to:
use a large language model (LLM) to process the transcript and to generate an output used to present the audio and/or the text.

29. The apparatus of claim 1, wherein the instructions are executable to:
determine that, for a threshold amount of time and while the person is within a threshold distance to the user, the user continually looks at the person but does not speak to the person; and
based on the determination, control the speaker to output the audio and/or control the smart glasses to display the text.

30. The apparatus of claim 29, wherein continually looking at the person comprises looking at the person without breaking eye contact.

31. The apparatus of claim 30, wherein the determination is made using eye tracking software.

32. The method of claim 13, wherein continually looking at the person comprises looking at the person without breaking eye contact.
